(19) United States
(12) Patent Application Publication
(10) Pub. No.: US 2010/0012804 A1
(43) Pub. Date: Jan. 21, 2010

(54) Apparatus for securing a hanging objection to a fixed object

(76) Inventor: Richard A. Egan, Riverside, CA (US)

Correspondence Address: Spyros J. Lazaris, Suite 107, 2133 S. Bentley Avenue, Los Angeles, CA, 90025, US

(21) Appl. No.: 12/218,945

(22) Filed: Jul. 18, 2008

(51) Int. Cl. F16B 2/22

(52) U.S. Cl. 248/231.81; 248/316.7; 248/291.1

(57) ABSTRACT

An object securing apparatus includes at least two clips detachable from each other and a fastener for coupling the two clips together. The fastener is temporary and configured to allow the first clip and the second clip to rotate independently of each other and to secure a hanging or non-fixed object to a fixed object at any angle. One of the clips is also capable of fitting within the other of the clips for ease of transportation and storage. The clips are also detachable to allow one of the clips to secure the hanging or non-fixed object to another non-fixed, movable object such as a person's wrist for hands-free activity.

### CROSS-REFERENCE TO RELATED APPLICATIONS

[Not Applicable]

### STATEMENT REGARDING FEDERALLY SPONSORED RESEARCH OR DEVELOPMENT

[Not Applicable]

### REFERENCE TO SEQUENCE LISTING, A TABLE, OR A COMPUTER PROGRAM LISTING COMPACT DISC APPENDIX

[Not Applicable]

### BACKGROUND OF THE INVENTION

The present invention relates to an apparatus for securing a hanging object to a fixed object. Specifically, the present invention relates to an apparatus having at least two clips and a temporary fastener for securing a cane or other hanging object to a fixed object such as a table.

The prior art includes several different devices for securing a hanging object, such as a cane, to a fixed object, such as a table or wheelchair. In one prior art device, found in US 20050098695 to Hollenbeck, a cane holder temporarily secures a cane to another structure through a pair of clips held together back-to-back by a permanent fastener. The clips can swivel relative to each other so that the axes of their jaws may be aligned as desired. Hollenbeck also includes a securing strap needed to positively secure an object therein. In contrast to the present invention, the clips of Hollenbeck do not, by themselves, allow a secure connection of a cane to a fixed object, and are not temporary coupled together to allow independent movement in multiple planes while still permitting a secure retention, nor are they detachable for an alternate use.

U.S. Pat. No. 6,565,053 to Larky teaches another prior art cane holder that also includes a permanent fastener coupling two clips together that can be configured to allow the two clips to pivot with respect to each other. Similar to Hollenbeck, Larky does not have a temporary fastener that allows independent movement of the clips relative to each other in multiple planes that still permits a secure retention of a cane to a fixed object and detachability for an alternate use.

U.S. Pat. No. 4,300,742 to Hunn teaches another cane holder that is capable of attaching a cane to a table top using an adjustable block. The adjustable block is a permanent fastener which is manually adjustable using grooves and lands. Similar to Hollenbeck and Larky, the device of Hunn does not include a detachable, temporary fastener that allows independent movement of the two portions of the cane holder while still permitting a secure retention of the cane to a fixed object and detachability for an alternate use.

U.S. Pat. No. 3,747,166 to Eross teaches a device for holding a hose having two C-shaped elements held together back-to-back by a swivel connection that permits freedom of movement of the hose relative to the holder. As with the other prior art devices, the swivel connection of Eross is a permanent fastener that does not permit independent movement of the elements relative to each other while still providing a secure retention of the hose, nor is it detachable to permit an alternate use with one of the clips.

U.S. Pat. No. 4,958,758 to Tipple et al. teaches a cane retaining strap that can fit over a user's wrist on one end, and includes a flexible cord having a loop for holding a cane. The retaining strap of Tipple is not configured to combine with another element to form a cane holder capable of securely affixing a cane or other object to a fixed object.

The prior art devices therefore do not teach the combined features of the present invention. Additionally, it would not be obvious to one of skill in the art to arrive at the present invention in light of the prior art because, given the state of the prior art at the time the of the invention a temporary fastener as disclosed in the present invention would not be secure enough to properly secure a hanging object such as a cane to a fixed object and still be configured to allow the clipping elements to rotate independent of each other and be detachable to permit an alternate use of one of the clips. It would further not be obvious to one of skill in the art to combine the features of the present invention to arrive at its alternate securing use, since Tipple cannot hold a cane to a fixed object, and none of the prior art references teach a fastener that allows easy detachability with a secure primary use.

### BRIEF SUMMARY OF THE INVENTION

In one embodiment of the present invention, an object securing apparatus comprises a first clip capable of fitting within a second clip and a detachable, temporary fastener coupling the first clip to the second clip so that the first clip and the second clip rotate independently of one another, wherein the detachable, temporary fastener allows the second clip to securely couple the object securing apparatus to a first object and a hanging object to be secured within the first clip at any angle relative to the first object.

In another embodiment of the present invention, an apparatus for securing one object to another object comprises a first clip detachably and independently coupled to a second clip by a fastener that allows a larger one of the first clip and the second clip to securely couple to a fixed object and a smaller one of the first clip and the second clip to securely hold a non-fixed object at any angle relative to the fixed object, wherein the fastener allows a smaller one of the first clip and the second clip to be completely detached from the larger one of the first clip and the second clip for securely tethering either of the smaller one and the larger one to another fixed object.

In another embodiment of the present invention, an apparatus configured to secure at least two objects to each other comprises a temporary fastening means detachably coupling a first clipping mechanism to a second clipping mechanism, wherein the temporary fastener allows the first and second clipping mechanisms to rotate in a common plane and to rotate in an opposite plane to enable secure attachment of a first object to a second object.

In yet another embodiment of the present invention, an object securing apparatus comprises a first clip capable of fitting within a second clip, and a temporary fastener coupling the first clip to the second clip so that the first clip and the second clip rotate relative to each other along a common axis to allow the first clip to be positioned within the second clip, wherein positioning a hanging object within the first clip when the first clip is rotated to fit within the second clip allows for storage of the object securing apparatus on the hanging object and positioning a fixed object within the first clip when the first clip is rotated to fit within the second clip allows for storage of the apparatus on the fixed object.

In yet another embodiment of the present invention, a cane holder comprises a pair of detachable clips adapted to securely couple a cane to a fixed object and a temporary fastener for coupling each one of the detachable clips in the pair of detachable clips to each other, where the temporary fastener permits the pair of detachable clips to move independently of each other to enable attachment of the cane at any angle relative to the fixed object.

In still another embodiment of the present invention, an apparatus comprises a first clip removably fastened to a second clip slightly larger than the first clip with a fastener that permits the first clip and the second clip to move independently of each other to allow at least one of the first clip and the second clip to be attachable to a first object so that the other of the first clip and the second clip is capable of securely holding a hanging object at any angle relative to the first object, and to allow the first clip to be folded over to rest within the second clip for compact storage of the apparatus.

It is therefore an object of the present invention to provide a device for securing a hanging object, such as a cane, to a fixed object, such as a table. The device according to the present invention includes two retentive clips fastened together by a temporary, detachable fastener that allows independent movement of the two retentive clips relative to each other and still provides a secure retention of the hanging object to the fixed object. Furthermore, it is an object of the present invention that such a device is capable of easy transportation and storage and that one of the clips is easily detachable so that it can be affixed to a non-fixed, movable object such as a person's wrist for securing the hanging object to the non-fixed, movable object for hands-free activity.

Other features and advantages of the present invention will become more apparent from the following description of the preferred embodiments, taken together with the accompanying drawings, which illustrate, by way of example, the principles of the invention.

### BRIEF DESCRIPTION OF THE SEVERAL VIEWS OF THE DRAWINGS

FIG. 1 is a top view of one embodiment of the present invention;

FIG. 2 is a perspective view of another embodiment of the present invention;

FIG. 3 is a perspective view of another embodiment of the present invention;

FIG. 4 is a top view showing a rotational aspect of elements of the present invention as indicated by the arrows of FIG. 3;

FIG. 6 is a top view of the present invention in a different angle of use according to another embodiment of the present invention; and

FIG. 7 is an exploded view of yet another embodiment of the present invention.

### DETAILED DESCRIPTION OF THE INVENTION

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

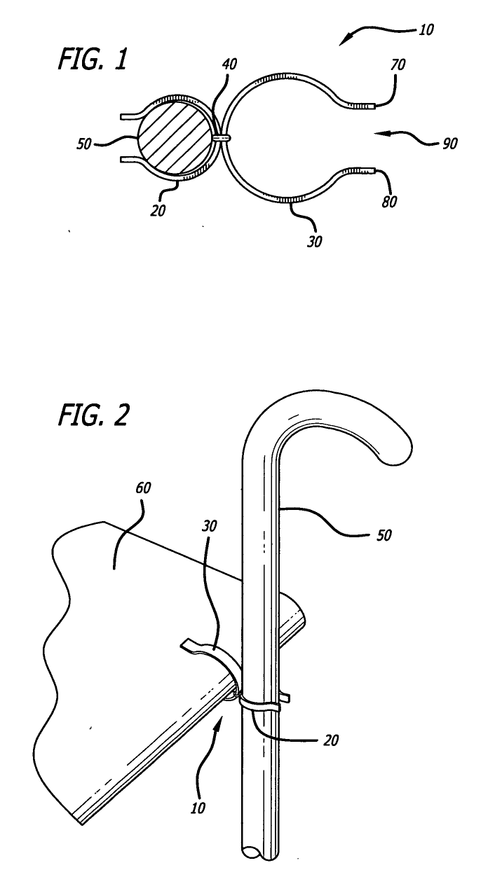

An object securing apparatus 10 according to the present invention is shown in FIGS. 1-7. Object securing apparatus 10 includes a first clip 20 and a second clip 30 coupling together by a fastener 40. A non-fixed or hanging object 50 is capable of being secured in one of first clip 20 or second clip 30 of the object securing apparatus 10 and then secured to a fixed object 60 with the other of first clip 20 or second clip 30.

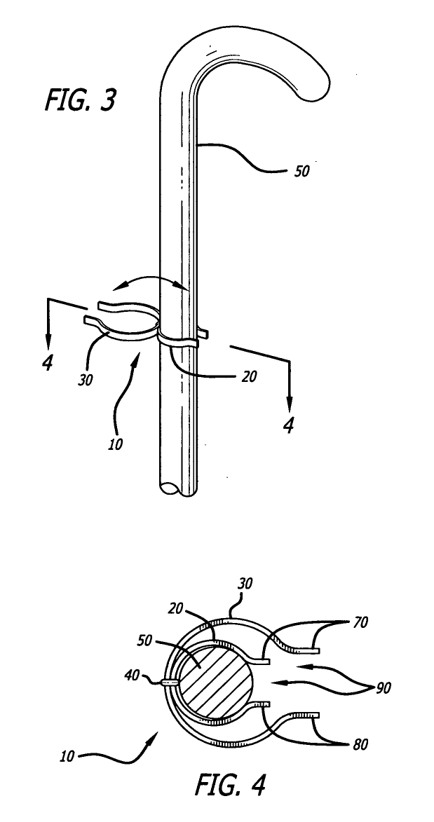

FIG. 1 is one view of object securing apparatus 10 in which first clip 20 and second clip 30 lie back to back relative to each other in the same plane. FIG. 3 shows the embodiment of FIG. 1 securing a hanging object 50, such as a cane, to a fixed surface 60, such as a table.

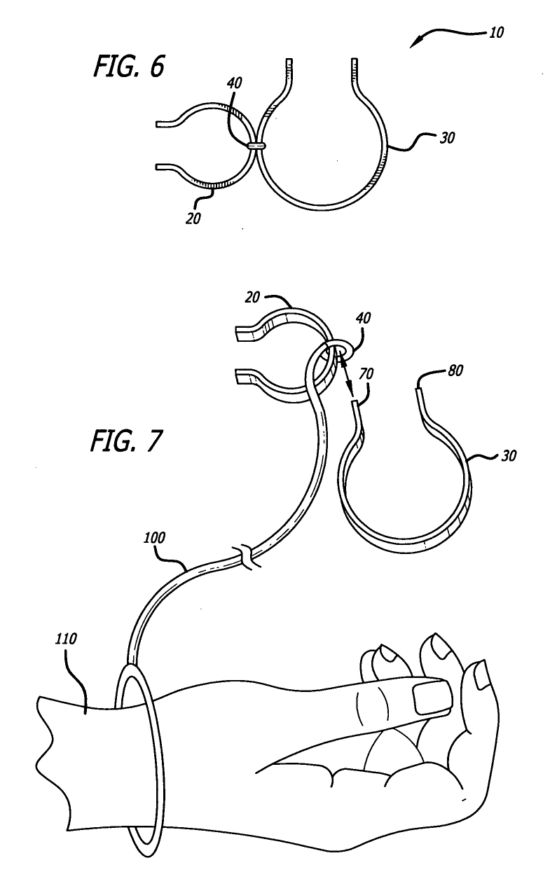

Fastener 40 is a temporary fastener that allows first clip 20 and second clip 30 to move independently so that they can be positioned in different planes and at different angles relative to each other. FIG. 2 illustrates an alternative positioning of first clip 20 and second clip 30 from FIG. 3. In FIG. 2, first clip 20 and second clip 30 of object securing apparatus 10 are positioned in a perpendicular plane relative to each other for securing the hanging object 50 to the fixed object or surface 60. FIG. 6 illustrates yet another alternative positioning of first clip 20 and second clip 30. In FIG. 6, first clip 20 and second clip 30 are positioned in the same plane at a different angle relative to each than shown in FIG. 1. It should be noted that fastener 40 allows first clip 20 and second clip 30 to be positioned in any plane and at any angle relative to each other. Fastener 40 therefore allows first clip 20 and second clip 30 to be positioned at multiple planes and angles relative to each other and still provide the ability to secure a hanging object 50 to a fixed object 60.

According to one embodiment of the present invention, first clip 20 and second clip 30 are each molded to have an open portion 90 within which a hanging object 50 may be placed or for attaching the clip 20 or 30 to a fixed object or surface 60. A first end 70 is disposed opposed a second end 80 around open portion 90. First clip 20 and second clip 30 are molded so that first end 70 and second end 80 are biased to create tension to maintain a size of open portion 90 when a object is placed within the clip and to yield with tension when an object is passed between first end 70 and second end 80. In one embodiment, first clip 20 and second clip 30 are substantially circular with first end 70 and second end 80 forming open portion 90 as show in the Figures. Alternatively, first clip 20 and second clip 30 may be clipping mechanisms of any shape that permits hanging object 50 and fixed object 60 to be positioned within open portion 90 and maintained within the tensed bias of first end 70 and second end 80.

According to one embodiment of the present invention, fastener 40 of object securing apparatus 10 is a flexible, molded ring. The flexible molded ring is of an appropriate size to allow rotation and movement of first clip 20 and second clip 30 in multiple planes and of appropriate strength to allow a hanging object 50 to be secured to a fixed object 60. Fastener 40 is also temporary to allow first clip 20 and second clip 30 to be detached from each other as shown in FIG. 7.

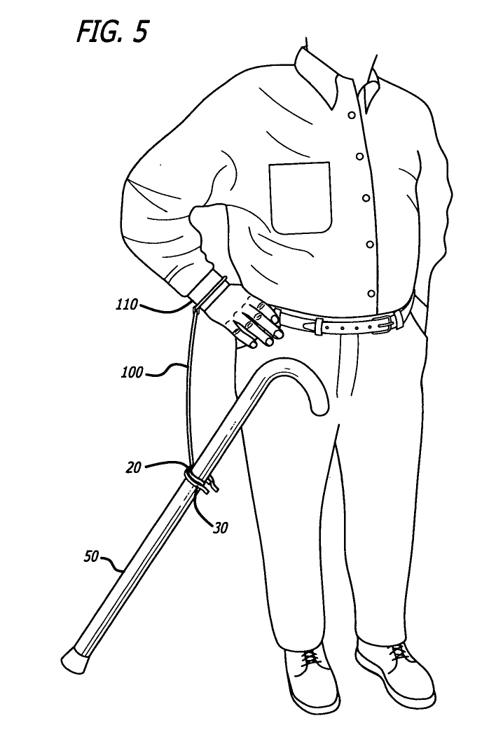

In addition to permitting first clip 20 and second clip 30 to lie in any plane relative to each to other as shown in FIG. 1, FIG. 2, and FIG. 3, fastener 40 allows the first clip 20 and the second clip 30 to rotate relative to each other so that first clip 20 can be rotated to be positioned within second clip 30 as shown in FIG. 4. This embodiment of the present invention allows object securing apparatus 10 to be easily transported and stored, such as for example on a hanging object itself as indicated in FIG. 4, or in one's pocket.

A tether 100 may also be attached to fastener 40 on one end and to another object 110 on another end, such as a person's wrist for example. FIG. 5 shows a hanging object 50 secured within first clip 20 and tethered via tether 100 to a person's wrist 110. First clip 20 is positioned within second clip 30 as described above and shown in FIG. 4. Tethering the object securing apparatus 10 via tether 100 connected to fastener 40 and to a person's wrist 110 allows a user of a cane to engage in hands-free activity without fear or dropping, losing, or misplacing his or her cane.

First clip 20 may also be detached from second clip 30 to allow tether 100 to be coupled to one of either first clip 20 or second clip 30 via fastener 40 as shown in FIG. 7. Tether 100 can be secured to one's wrist 110 via one end of tether 100 and to either clip of first clip 20 or second clip 30 to which fastener 40 is still coupled. Hanging object 50 is then secured to the clip retaining fastener 40.

Fastener 40 of object securing apparatus 10 allows detachability of first clip 20 from second clip 30 by sliding one of first clip 20 and second clip 30 relative to the other and slipping fastener 40 over one of ends 70 or 80 of one of the clips 20 or 30 as shown in FIG. 7. Fastener 40 is therefore flexible and strong enough to be slipped off of and onto an end 70 or 80 of each clip multiple times and still retain its shape to securely hold first clip 20 and second clip 30 together to then secure a hanging object 50 to a fixed object 60.

It is to be understood that other embodiments may be utilized and structural and functional changes may be made without departing from the scope of the present invention. The foregoing descriptions of embodiments of the invention have been presented for the purposes of illustration and description. It is not intended to be exhaustive or to limit the invention to the precise forms disclosed. Accordingly, many modifications and variations are possible in light of the above teachings. For example, first clip 20 and second clip 30 may be different shapes and sizes than pictured and described above, and from each other. Additionally, first end 70 and second end 80 forming open portion 90 may be configured to form different shapes than those shown and described above while providing a secure space within which an object can be placed and still providing enough strength to secure the object within. Furthermore, object securing apparatus 10 may be used to secure many different objects and is not limited to use with canes. Other objects such as paint brushes and tools may also be used. It is therefore intended that the scope of the invention be limited not by this detailed description.

1. An object securing apparatus comprising:
a first clip capable of fitting within a second clip;
a detachable, temporary fastener coupling the first clip to the second clip so that the first clip and the second clip rotate independently of one another, wherein the detachable, temporary fastener allows the second clip to securely couple the object securing apparatus to a first object and a hanging object to be secured within the first clip at any angle relative to the first object.

2. The object securing apparatus of claim 1, wherein the detachable, temporary fastener is a flexible ring permitting the first clip and the second clip to rotate relative to each other in a common plane.

3. The object securing apparatus of claim 1, wherein the detachable, temporary fastener is a flexible ring permitting the first clip and the second clip to rotate relative to each other to be positioned in opposite, angular planes.

4. The object securing apparatus of claim 1, wherein the first clip and the second clip are positioned opposite each other in a common plane to secure the hanging object to the first object.

5. The object securing apparatus of claim 1, wherein the first clip and the second clip are positioned opposite each other in planes angular to each other to secure the hanging object at any angle relative to the first object.

6. The object securing apparatus of claim 1 wherein the second clip is slightly larger than the first clip.

7. The object securing apparatus of claim 1, wherein the detachable, temporary fastener allows the second clip and the first clip to rotate relative to each other so that the first clip fits within the second clip in a common plane.

8. The object securing apparatus of claim 1, wherein the detachable, temporary fastener allows the second clip to detach from the first clip.

9. The object securing apparatus of claim 1, wherein each of the first and second clips include an open portion having two ends oppositely biased to create tension so as to secure an object when positioned between the two ends.

10. An apparatus for securing one object to another object, comprising:
a first clip detachably and independently coupled to a second clip by a fastener that allows a larger one of the first clip and the second clip to securely couple to a fixed object and a smaller one of the first clip and the second clip to securely hold a non-fixed object at any angle relative to the fixed object, wherein the fastener allows a smaller one of the first clip and the second clip to be completely detached from the larger one of the first clip and the second clip for securely tethering either of the smaller one and the larger one to another fixed object.

11. The apparatus of claim 10, wherein the fastener is a flexible ring permitting the first clip and the second clip to rotate relative to each other in a common plane.

12. The apparatus of claim 10, wherein the fastener is a flexible ring permitting the first clip and the second clip to rotate relative to each other in opposite, angular planes.

13. The apparatus of claim 10, wherein the first clip and the second clip are positioned opposite each other in a common plane to secure the non-fixed object to the fixed object.

14. The apparatus of claim 10, wherein the first clip and the second clip are positioned opposite each other in planes angular to each other to secure the non-fixed object at any angle relative to the fixed object.

15. The apparatus of claim 10, wherein the second clip is slightly larger than the first clip.

16. The apparatus of claim 10, wherein the fastener allows the second clip and the first clip to rotate relative to each other so that the first clip fits within the second clip in a common plane.

17. The apparatus of claim 11, wherein each of the first and second clips include an open portion having two ends oppositely biased to create tension so as to secure an object when positioned between the two ends.

18. An apparatus configured to secure at least two objects to each other, comprising
a temporary fastening means detachably coupling a first clipping mechanism to a second clipping mechanism, wherein the temporary fastener allows the first and second clipping mechanisms to rotate in a common plane and to rotate in an opposite plane to enable secure attachment of a first object to a second object.

19. The apparatus of claim 18, wherein the temporary fastening means is a flexible ring permitting the first clipping mechanism and the second clipping mechanism to rotate relative to each other in a common plane.

20. The apparatus of claim 18, wherein the temporary fastening means is a flexible ring permitting the first clipping mechanism and the second clipping mechanism to rotate relative to each other in opposite, angular planes.

21. The apparatus of claim 18, wherein the first clipping mechanism and the second clipping mechanism are positioned opposite each other in the common plane to secure the first object to the second object.

22. The apparatus of claim 19, wherein the first clipping mechanism and the second clipping mechanism are positioned opposite each other in planes angular to each other to secure the first object at any angle relative to the second object.

23. The apparatus of claim 18, wherein the second clipping mechanism is slightly larger than the first clipping mechanism.

24. The apparatus of claim 18, wherein the temporary fastening means allows the second clipping mechanism and the first clipping mechanism to rotate relative to each other so that the first clipping mechanism fits within the second clipping mechanism in a common plane.

25. The apparatus of claim 18, wherein the temporary fastening means allows the second clipping mechanism to detach from the first clipping mechanism.

26. The apparatus of claim 18, wherein each of the first and second clipping mechanisms include an open portion having two ends oppositely biased to create tension so as to secure one of the first object and the second object when positioned between the two ends.

27. A object securing apparatus comprising:
a first clip capable of fitting within a second clip;
a temporary fastener coupling the first clip to the second clip so that the first clip and the second clip rotate relative to each other along a common axis to allow the first clip to be positioned within the second clip,
wherein positioning a hanging object within the first clip when the first clip is rotated to fit within the second clip allows for storage of the object securing apparatus on the hanging object and positioning a fixed object within the first clip when the first clip is rotated to fit within the second clip allows for storage of the apparatus on the fixed object.

28. The object securing apparatus of claim 27, wherein the temporary fastener is a flexible ring.

29. The object securing apparatus of claim 27, wherein the temporary fastener is a flexible ring permitting the first clip and the second clip to rotate relative to each other in opposite, angular planes.

30. The object securing apparatus of claim 27, further comprising a tether attachable to the temporary fastener to permit hands free activity when a hanging object is positioned within the first clip and the first clip is rotated to fit within the second clip.

31. The object securing apparatus of claim 27, wherein the second clip is slightly larger than the first clip.

32. The object securing apparatus of claim 27, wherein the temporary fastener allows the second clip to detach from the first clip.

33. The object securing apparatus of claim 27, wherein each of the first and second clips include an open portion having two ends oppositely biased to create tension so as to secure an object when positioned between the two ends.
